(19) United States
(12) Patent Application Publication
(10) Pub. No.: US 2008/0264059 A1
(43) Pub. Date: Oct. 30, 2008

(54) Control apparatus and control method for negative pressure generating apparatus

(75) Inventor: Shigemasa Hirooka, Susono-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/149,068

(22) Filed: Apr. 25, 2008

(30) Foreign Application Priority Data
Apr. 25, 2007 (JP) 2007-116260

(51) Int. Cl. B60T 13/57

(52) U.S. Cl. 60/547.1

(57) ABSTRACT

A control apparatus for a negative pressure generating apparatus includes an ejector that generates a negative pressure whose magnitude is larger than that of a negative pressure to be taken from an intake passage in an intake system for an internal combustion engine provided in a vehicle; a state change device that makes the ejector function or stop functioning; and a predetermined value change device that changes a predetermined value according to an operating state of the vehicle, when the state change device makes the ejector function based on a result of a comparison between the negative pressure to be taken from the intake passage and the predetermined value.

### INCORPORATION BY REFERENCE

The disclosure of Japanese Patent Application No. 2007-116260 filed on Apr. 25, 2007 including the specification, drawings and abstract is incorporated herein by reference in its entirety.

### BACKGROUND OF THE INVENTION

1. Field of the Invention

The invention relates to a control apparatus and a control method for a negative pressure generating apparatus. More specifically, the invention relates to a control apparatus and a control method for a negative pressure generating apparatus, which make an ejector function based on a negative pressure to be taken from an intake passage.

2. Description of the Related Art

In a vehicle, an ejector is used to supply a negative pressure whose magnitude is larger than that of a negative pressure to be taken from an intake passage (for example, an intake manifold or a surge tank) in an intake system for an internal combustion engine, to a negative pressure operating device such as a brake booster (hereinafter, the negative pressure to be taken from the intake passage may be referred to as “intake pipe negative pressure”). The above-described ejector is described, for example, in Japanese Patent Application Publication No. 2005-297654 (JP-A-2005-297654).

If the ejector is used, for example, when the magnitude of the intake pipe negative pressure is decreased, the negative pressure whose magnitude is larger than that of the intake pipe negative pressure can be supplied to the brake booster. Therefore, it is possible to ensure brake performance to some extent. However, in reality, the required level of brake performance considerably varies depending on the state of a vehicle. More specifically, for example, when a vehicle speed is high, the required level of brake performance is high. Therefore, when the ejector is used based on the result of a comparison between the intake pipe negative pressure and a predetermined value, and the predetermined value is a fixed constant value, a desired level of brake performance may not be ensured, depending on the operating state of the vehicle.

### SUMMARY OF THE INVENTION

The invention provides a control apparatus and a control method for a negative pressure generating apparatus, which ensure a required level of brake performance.

A first aspect of the invention relates to a control apparatus for a negative pressure generating apparatus. The control apparatus includes an ejector that generates a negative pressure whose magnitude is larger than that of a negative pressure to be taken from an intake passage in an intake system for an internal combustion engine provided in a vehicle; a state change device that makes the ejector function or stop functioning based on a result of a comparison between the negative pressure to be taken from the intake passage and a predetermined value; and a predetermined value change device that changes a predetermined value according to an operating state of the vehicle. More specifically, the operating state of the vehicle changes the required level of brake performance. According to the above-described aspect, because the predetermined value is changed according to the operating state of the vehicle, it is possible to appropriately ensure the required level of brake performance.

The negative pressure to be taken from the intake passage may be indicated by a negative value, and the negative value may be compared with the predetermined value. However, the comparison need not necessarily be made in this manner. The magnitude or the absolute value of the negative pressure to be taken from the intake passage may be compared with the predetermined value. Also, in the above-described publication No. 2005-297654, the state of a switching valve (that may be regarded as the state change device) is changed based on the result of a comparison between a negative pressure in a negative pressure chamber of a brake booster and a switching threshold value. Further, the switching threshold value is changed when the state of the internal combustion engine is changed between a cold state and a warm state. In contrast, according to the invention, the predetermined value is changed taking into account the required level of brake performance. Thus, the technical idea in the invention differs from the technical idea in the publication No. 2005-297654 in which the required level of brake performance is not taken into account. Also, according to the invention, for example, the intake pipe negative pressure estimated based on the rotational speed of the internal combustion engine and the opening degree of a throttle valve may be compared with the predetermined value. Therefore, as compared to the case where the negative pressure in the negative pressure chamber is compared with the switching threshold value, it is possible to reduce the cost of the entire vehicle because a pressure sensor that detects a negative pressure does not need to be provided.

A second aspect of the invention relates to a control method for a negative pressure generating apparatus that includes an ejector that generates a negative pressure whose magnitude is larger than that of a negative pressure to be taken from an intake passage in an intake system for an internal combustion engine provided in a vehicle. The control method includes making a comparison between the negative pressure to be taken from the intake passage and the predetermined value, making the ejector function based on a result of the comparison, and changing a predetermined value according to an operating state of the vehicle.

### BRIEF DESCRIPTION OF THE DRAWINGS

The foregoing and further objects, features and advantages of the invention will become apparent from the following description of embodiments with reference to the accompanying drawings, wherein like numerals are used to represent like elements and wherein:

FIG. 1 is a schematic diagram showing a control apparatus for a negative pressure generating apparatus according an embodiment of the invention, along with the negative pressure generating apparatus;

FIG. 2 is a schematic diagram showing the configuration of an inside of an ejector shown in FIG. 1;

FIG. 3 is a diagram showing a flowchart of a routine executed by the control apparatus for the negative pressure generating apparatus according to the embodiment of the invention; and

FIGS. 4A to 4F are flowcharts (FIGS. 4A to 4C) of sub routines, each of which shows a process of calculating a negative pressure determination value F (P) shown in FIG. 3, and negative pressure determination value maps (FIGS. 4D to 4F).

### DETAILED DESCRIPTION OF EMBODIMENTS

Hereinafter, an embodiment of the invention will be described in detail with reference to the drawings.

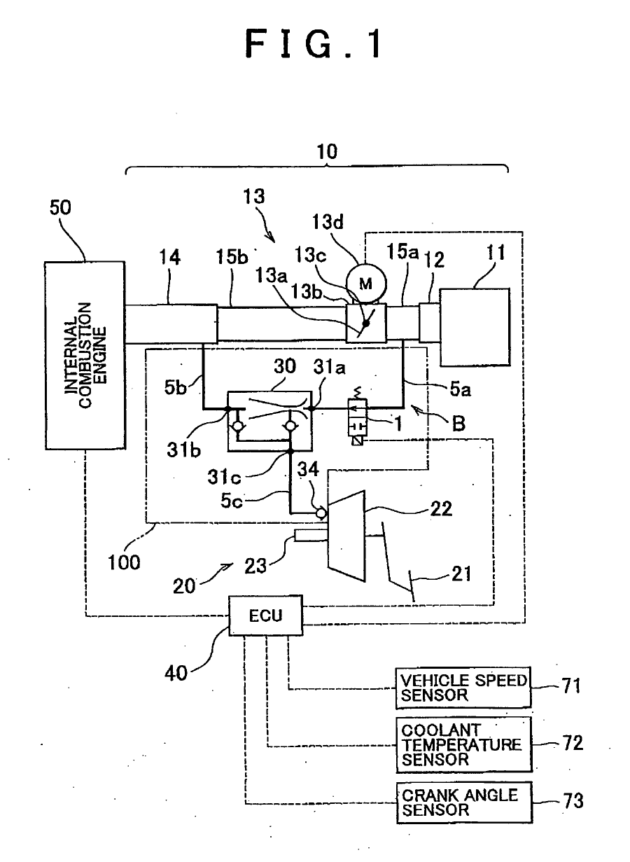

FIG. 1 is a schematic diagram showing a control apparatus for a negative pressure generating apparatus according to an embodiment of the invention, along with a negative pressure generating apparatus 100. The control apparatus is implemented by an ECU (Electronic Control Unit) 40. Components shown in FIG. 1, which include an internal combustion engine 50, are provided in a vehicle (not shown). An intake system 10 for the internal combustion engine 50 includes an air cleaner 11, an airflow meter 12, an electric throttle 13, an intake manifold 14, intake ports (not shown) connected to cylinders (not shown) of the internal combustion engine 50, and members (for example, intake pipes 15a and 15b) that are appropriately provided among the components. The air cleaner 11 filters intake air supplied to the cylinders of the internal combustion engine 50. The atmospheric air flows into the air cleaner 11 through an air duct (not shown). The airflow meter 12 measures the amount of intake air, and outputs a signal corresponding to the amount of intake air.

The electric throttle 13 includes a throttle valve 13a, a throttle body 13b, a valve shaft 13c, and an electric motor 13d. The amount of intake air supplied to the internal combustion engine is adjusted by changing the opening degree of the throttle valve 13a. The throttle body 13b is a cylindrical member in which an intake passage is formed. The throttle body 13b supports the valve shaft 13c for the throttle valve 13a provided in the intake passage. The electric motor 13d changes the opening degree of the throttle valve 13a according to a control executed by the ECU 40. As the electric motor 13d, a step motor is employed. The electric motor 13d is fixed to the throttle body 13b. An output shaft (not shown) of the electric motor 13d is connected to the valve shaft 13c. The ECU 40 detects the opening degree of the throttle valve 13a, based on a signal output from a throttle-valve opening degree sensor (not shown) provided in the electric throttle 13.

As the throttle mechanism, the electric throttle 13 is employed. The electric throttle 13 is a throttle-by-wire throttle mechanism, and the throttle valve 13a is driven by the actuator. Instead of the electric throttle 13, a mechanical throttle mechanism may be employed. In the mechanical throttle mechanism, for example, the opening degree of the throttle valve 13a is changed according to operation of an accelerator pedal (not shown) using a wire or the like. In the intake manifold 14, one intake passage on an upstream side is divided into a plurality of branch intake passages on a downstream side. The branch intake passages on the downstream side correspond to the respective cylinders of the internal combustion engine 50. Thus, the intake manifold 14 distributes intake air into the cylinders of the internal combustion engine 50.

A brake device 20 includes a brake pedal 21, a brake booster (negative pressure operating device) 22, a master cylinder 23, and wheel cylinders (not shown). A driver operates the brake pedal 21 to apply a brake to the rotation of wheels. The brake pedal 21 is connected to an input rod (not shown) of the brake booster 22. The brake booster 22 generates an assist force so that the ratio of the assist force to a pedal depression force is equal to a predetermined ratio. In the brake booster 22, a negative pressure chamber (not shown) close to the master cylinder 23 is connected to the intake passage in the intake manifold 14 through an ejector 30. An output rod (not shown) of the brake booster 22 is connected to an input shaft (not shown) of the master cylinder 23. The master cylinder 23 generates a hydraulic pressure according to an acting force from the brake booster 22 that obtains the assist force in addition to the pedal depression force. The master cylinder 23 is connected to the wheel cylinder provided in a disc brake mechanism (not shown) for each wheel via a hydraulic circuit. The wheel cylinder generates a braking force using the hydraulic pressure supplied to the wheel cylinder from the master cylinder 23. The brake booster 22 is not limited to a specific brake booster, and may be an ordinary brake booster, as long as the brake booster 22 is a pneumatic brake booster.

The ejector 30 generates a negative pressure whose magnitude is larger than that of a negative pressure (i.e., an intake pipe negative pressure) to be taken from the intake system 10, more specifically, the intake manifold 14 downstream of the throttle valve 13a, and supplies the generated negative pressure to the negative pressure chamber of the brake booster 22. The ejector 30 includes an inflow port 31a, an outflow port 31b, and a negative pressure supply port 31c. The negative pressure supply port 31c among the ports is connected to the negative pressure chamber of the brake booster 22 by an air hose 5c. The inflow port 31a is connected to the intake passage in the intake pipe 15a by an air hose 5a at a position upstream of the electric throttle 13, more specifically, the throttle valve 13a. The outflow port 31b is connected to the intake passage in the intake manifold 14 by an air hose 5b at a position downstream of the electric throttle 13, more specifically, the throttle valve 13a. Thus, a bypass passage B that bypasses the electric throttle 13 is formed by the ejector 30 and the air hoses 5a and 5b. When the ejector 30 does not function, the negative pressure is supplied to the negative pressure chamber of the brake booster 22 from the intake passage in the intake manifold 14 through the air hose 5b, the outflow port 31b and the negative pressure supply port 31c of the ejector 30, and the air hose 5c.

The air hose 5a is provided with a VSV (Vacuum Switching Valve) 1. The VSV1 opens/closes the bypass passage B according to a control executed by the ECU 40. In the embodiment, as the VSV1, a normally-closed solenoid valve with two positions and two ports is employed. However, the VSV1 is not limited to this valve. For example, other appropriate electromagnetic valves may be employed as the VSV1. Further, for example, the VSV1 may be a flow rate regulating valve that controls the flow rate of the intake air flowing in a flow passage. The VSV1 makes the ejector 30 function or stop functioning by opening or closing the bypass passage B. In the embodiment, the state change device is implemented by the VSV1.

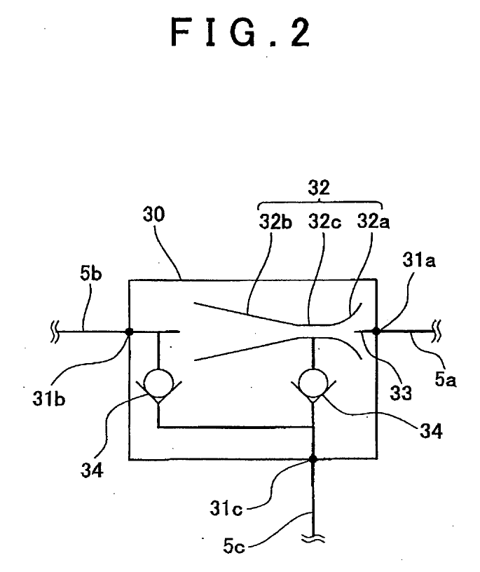

FIG. 2 is a schematic diagram showing the configuration of an inside of the ejector 30 shown in FIG. 1. A diffuser 32 is provided inside the ejector 30. The diffuser 32 includes a taper portion 32a, a taper portion 32b, and a negative pressure obtaining portion 32c that serves as a passage connecting the taper portions 32a and 32b. The diameter of the taper portion 32a decreases toward the outflow port 31b, and the diameter of the taper portion 32b increases toward the outflow port 31b. The taper portion 32a is open toward the inflow port 31a. The taper portion 32b is open toward the outflow port 31b. The negative pressure obtaining portion 32c is connected to the negative pressure supply port 31c. The inflow port 31a is provided with a nozzle 33 that injects the intake air, which has flown to the ejector 30, toward the taper portion 32a. The intake air injected from the nozzle 33 flows through the diffuser 32, and flows out from the outflow port 31b to the air hose 5b. At this time, a high-speed jet is generated in the diffuser 32, and accordingly, a great negative pressure is generated in the negative pressure obtaining portion 32c using the venturi effect. Further, the negative pressure is supplied from the negative pressure supply port 31c to the negative pressure chamber through the air hose 5c. Using this function of the ejector 30, it is possible to obtain the negative pressure whose magnitude is larger than that of the negative pressure to be taken from the intake manifold 14.

Check valves 34 are provided in an inner passage between the negative pressure obtaining portion 32c and the negative pressure supply port 31c, in an inner passage between the outflow port 31b and the negative pressure supply port 31c, and in a connection portion of the brake booster 22, to which the air hose 5c is connected. Each of the check valves 32 prevents a backflow. The ejector 30 need not necessarily have the inner structure shown in FIG. 2. Other ejectors that have inner structures different from the inner structure shown in FIG. 2 may be employed, instead of the ejector 30. In the embodiment, a negative pressure generating apparatus 100 includes the VSV1 and the ejector 30. More specifically, the negative pressure generating apparatus 100 includes the air hoses 5a, 5b, and 5c, and the check valves 34.

The ECU 40 includes a microcomputer (not shown) and input/output circuits (not shown). The microcomputer includes a CPU (Central Processing Unit), a ROM (Read Only Memory), and a RAM (Random Access Memory). The ECU 40 mainly controls the internal combustion engine 50. In the embodiment, the ECU 40 also controls the VSV1 and the electric throttle 13. The ECU 40 is connected to the VSV1, the electric throttle 13, and other devices to be controlled by the ECU 40. The ECU 40 is also connected to sensors, such as the throttle-valve opening degree sensor, a vehicle speed sensor 71 that detects a vehicle speed, a coolant temperature sensor 72 that detects the temperature of a coolant for the internal combustion engine 50, a crank angle sensor 73 that detects a rotational speed NE of the internal combustion engine 50.

The ROM stores programs in which processes to be executed by the CPU are described. In the embodiment, the ROM stores, for example, an engine control program used to control the internal combustion engine 50, and a VSV1 control program used to control the VSV1 to make the ejector 30 function or stop functioning (i.e., to open or close the VSV1) under various conditions. The programs may be integrated with each other. The VSV1 control program includes a negative pressure supply program used to open the VSV1 when the opening degree of the throttle valve 13a is smaller than a predetermined opening degree α.

Further, the negative pressure supply program is configured to open the VSV1 when the intake pipe negative pressure is a negative value larger than a negative pressure determination value F (P). Therefore, the VSV1 control program includes an intake pipe negative pressure determination program used to determine whether the intake pipe negative pressure is a negative value larger than the negative pressure determination value F (P). Accordingly, in the embodiment, the intake pipe negative pressure is compared with the negative pressure determination value F (P) according to the intake pipe negative pressure determination program, and the VSV1 is opened based on the result of the comparison, according to the negative pressure supply program.

Further, in the embodiment, the VSV1 control program includes a negative pressure determination value change program used to change the negative pressure determination value F (P) according to the operating stale of the vehicle. In the embodiment, the control device, the detection device, the determination device, and the like are implemented by the microcomputer and the above-described programs. Particularly, the predetermined value change device is implemented by the microcomputer and the negative pressure determination value change program.

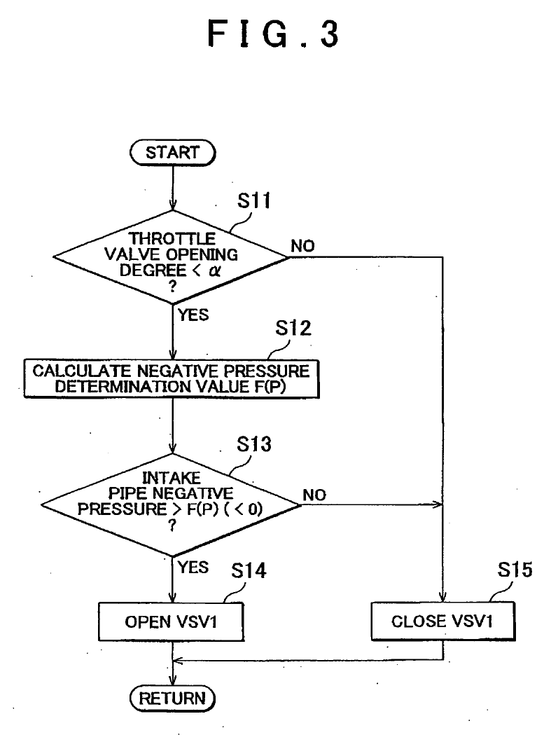

Next, a routine executed by the ECU 40 will be described in detail with reference to a flowchart shown in FIG. 3. The CPU repeatedly executes the routine shown by the flowchart, according to the above-described programs stored in the ROM, at extremely short time intervals, and thus, the ECU 40 changes the negative pressure determination value F (P) according to the state of the vehicle. The CPU determines whether the opening degree of the throttle valve 13a is smaller than the predetermined opening degree a (step S11). When the accelerator pedal is released, the opening degree of the throttle valve 13a decreases to a certain opening degree. The predetermined opening degree α is set to be close to, and larger than the certain opening degree. When a negative determination is made in step S11, the CPU closes the VSV1 (step S15). When an affirmative determination is made in step S11, the CPU calculates the negative pressure determination value F (P) (step S12). In step S12, the negative pressure determination value F (P) is newly calculated according to the state of the vehicle. A calculation process executed in this step will be described in detail later.

Subsequently, the CPU determines whether the intake pipe negative pressure is a negative value larger than the negative pressure determination value F (P) (step S13). For example, the intake pipe negative pressure is estimated based on the engine speed NE and the opening degree of the throttle valve 13a. However, the intake pipe negative pressure need not necessarily be estimated based on the engine speed NE and the opening degree of the throttle valve 13a A pressure sensor, which detects the intake pipe negative pressure, may be provided, and the intake pipe negative pressure may be detected based on an output from the pressure sensor. When a negative determination is made in step S13, the CPU proceeds to step S15. When an affirmative determination is made in step S13, the CPU opens the VSV1 (step S14). The negative pressure determination value F (P) used in step S13 is the negative pressure determination value F (P) that is newly calculated in step S12, that is, the negative pressure determination value F (P) that is changed according to the state of the vehicle. Therefore, the required level of brake performance is appropriately ensured.

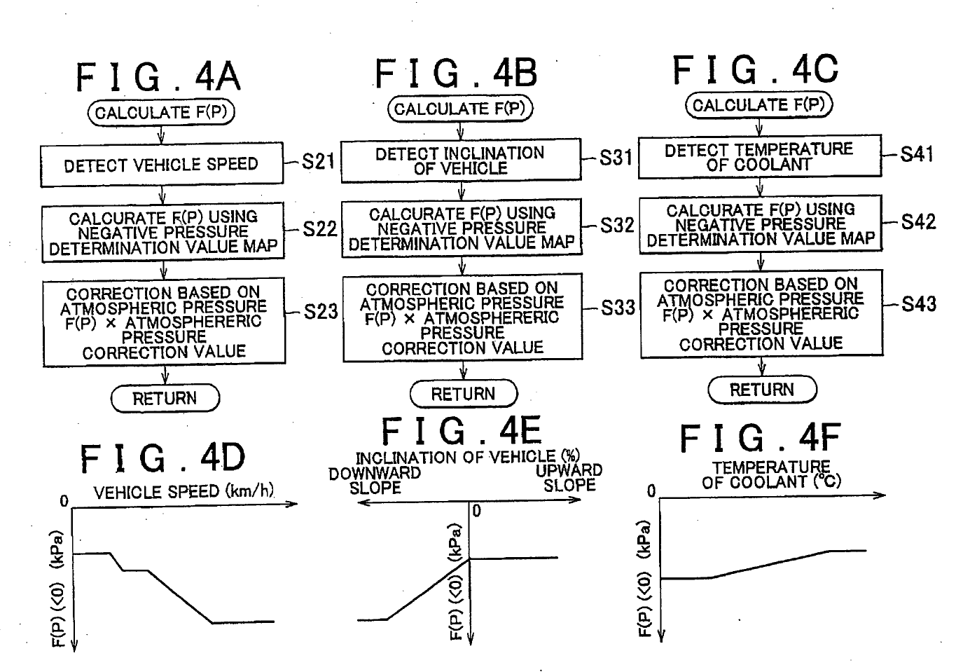

Next, the calculation process executed in step S12 will be described in detail with reference to the flowcharts of the sub routines shown in FIGS. 4A to 4C. The calculation process may be executed in step S12, for example, according to the flowchart shown in FIG. 4A, using the vehicle speed as the state of the vehicle. First, the CPU detects the vehicle speed (step S21). Then, the CPU newly reads the negative pressure determination value F (P) corresponding to the detected vehicle speed, with reference to map data shown in FIG. 4D (hereinafter, the map data, which defines the negative pressure determination value F (P) according to the operating state of the vehicle, will be referred to as “negative pressure determination value map”) (step S22). That is, the negative pressure determination value F (P) is defined according to the vehicle speed in the negative pressure determination value map shown in FIG. 4D. In the negative pressure determination value map, the negative pressure determination value F (P) is set to a negative value, and the negative pressure determination value F (P) decreases in a stepwise manner as the vehicle speed increases. In other words, the absolute value of the negative pressure determination value F (P) increases as the vehicle speed increases. Accordingly, when the vehicle speed is high, an affirmative determination is made in step S13 before the intake pipe negative pressure is considerably decreased. Therefore, it is possible to ensure a high level of brake performance corresponding to the vehicle speed. Also, it is possible to more appropriately ensure the required level of brake performance, using the negative pressure determination value map that defines the negative pressure determination value F (P) according to the state of the vehicle.

Then, the CPU corrects the negative pressure determination value F (P) that is newly read, based on an atmospheric pressure (step S23). More specifically, the negative pressure determination value F (P) is corrected based on the atmospheric pressure, by multiplying the newly-read negative pressure determination value F (P) by an atmospheric pressure correction value (for example, a coefficient value corresponding to a difference between the standard atmospheric pressure and a current atmospheric pressure). Thus, the sub routine is finished, and the CPU proceeds to step S13. The process of changing the negative pressure determination value F (P) according to the vehicle speed may be implemented by configuring the negative pressure determination value change program using the vehicle speed as the state of the vehicle. More specifically, the process of changing the negative pressure determination value F (P) according to the vehicle speed may be implemented by storing the negative pressure determination value map shown in FIG. 4D in the ROM, and configuring the negative pressure determination value change program so that the negative pressure determination value map shown in FIG. 4D is referred to, based on the detected vehicle speed, and the negative pressure determination value F (P) corresponding to the detected vehicle speed is newly read from the negative pressure determination value map. The process of correcting the negative pressure determination value F (P) based on the atmospheric pressure may be implemented by storing, in the ROM, an atmospheric pressure correction program used to correct the changed negative pressure determination value F (P) based on the atmospheric pressure when the negative pressure determination value F (P) is changed. At this time, the atmospheric pressure correction device is implemented by the microcomputer and the atmospheric pressure correction program.

The calculation process may be executed in step S12, for example, according to a flowchart shown in FIG. 4B using the inclination of the vehicle as the state of the vehicle. The inclination of the vehicle indicates a posture of the vehicle (more specifically, the inclination of the vehicle in the longitudinal direction of the vehicle) that changes according to the slope of a road on which the vehicle travels. For example, an inclination detection sensor, which detects the inclination of the vehicle in the longitudinal direction of the vehicle, may be further provided, and the inclination of the vehicle may be detected based on an output from the inclination detection sensor. Also, for example, when the vehicle is provided with a navigation system in which the inclination of the vehicle in the longitudinal direction of the vehicle is detected using an inclination sensor or a gyro sensor, or a navigation system in which information on the slopes of roads is stored, the inclination of the vehicle in the longitudinal direction of the vehicle is detected using the navigation system.

The CPU detects the inclination of the vehicle (step S31). Then, the CPU newly reads the negative pressure determination value F (P) corresponding to the detected inclination of the vehicle, with reference to the negative pressure determination value map shown in FIG. 4E (step S32). That is, the negative pressure determination value F (P) is defined according to the inclination of the vehicle in the negative pressure determination value map shown in FIG. 4E. In the negative pressure determination value map, the negative pressure determination value F (P) is set to a negative value, and the negative pressure determination value F (P) decreases as the inclination of the vehicle increases, when the inclination of the vehicle indicates that the vehicle travels on a downward slope. Accordingly, when the inclination of the vehicle indicates that the vehicle travels on a downward slope, and the inclination of the vehicle is large, an affirmative determination is made in step S13 before the intake pipe negative pressure is considerably decreased. Therefore, it is possible to ensure a high level of brake performance according to the inclination of the vehicle. When the inclination of the vehicle indicates that the vehicle travels on an upward slope, the negative pressure determination value F (P) is set to a predetermined constant value.

Then, the CPU corrects the negative pressure determination value F (P) that is newly read, based on the atmospheric pressure (step S33). Thus, the sub routine is finished, and the CPU proceeds to step S13. The process of changing the negative pressure determination value F (P) according to the inclination of the vehicle may be implemented by configuring the negative pressure determination value change program using the inclination of the vehicle as the state of the vehicle. More specifically, the process of changing the negative pressure determination value F (P) according to the inclination of the vehicle may be implemented by storing, in the ROM, the negative pressure determination value map shown in FIG. 4E, and configuring the negative pressure determination value change program so that the negative pressure determination value map shown in FIG. 4E is referred to, based on the detected inclination of the vehicle, and the negative pressure determination value F (P) corresponding to the detected inclination of the vehicle is newly read from the negative pressure determination value map.

Further, the calculation process may be executed in step S12, for example, according to a flowchart shown in FIG. 4C using the temperature of the coolant for the internal combustion engine 50 as the state of the vehicle. First, the CPU detects the temperature of the coolant for the internal combustion engine 50 (step S41). Then, the CPU newly reads the negative pressure determination value F (P) corresponding to the detected temperature of the coolant, with reference to a negative pressure determination value map shown in FIG. 4F (step S42). That is, the negative pressure determination value F (P) is defined according to the temperature of the coolant in the negative pressure determination value map shown in FIG. 4F. In the negative pressure determination value map, the negative pressure determination value F (P) is set to a negative value, and the negative pressure determination value F (P) decreases as the temperature of the coolant decreases. Accordingly, when the temperature of the coolant is low, an affirmative determination is made in step S13 before the intake pipe negative pressure is considerably decreased. Therefore, it is possible to ensure a high level of brake performance corresponding to the temperature of the coolant, that is, a creep force.

Then, the CPU corrects the negative pressure determination value F (P) that is newly read, based on the atmospheric pressure (step S43). Thus, the sub routine is finished, and the CPU proceeds to step S13. The process of changing the negative pressure determination value F (P) according to the temperature of the coolant may be implemented by configuring the negative pressure determination value change program using the temperature of the coolant for the internal combustion engine 50 as the state of the vehicle. Further, more specifically, the process of changing the negative pressure determination value F (P) according to the temperature of the coolant may be implemented by storing, in the ROM, the negative pressure determination value map shown in FIG. 4F, and configuring the negative pressure determination value change program so that the negative pressure determination value map shown in FIG. 4F is referred to, based on the detected temperature of the coolant, and the negative pressure determination value F (P) corresponding to the detected temperature of the coolant is newly read from the negative pressure determination value map.

For example, a vehicle weight, an inter-vehicle distance, the weather, and the humidity level may be used as the operating state of the vehicle. For example, as the vehicle weight increases, an inertia force of the vehicle increases when the vehicle travels, and therefore, the required level of brake performance increases. Also, as the inter-vehicle distance decreases, the possibility that the vehicle will collide with a preceding vehicle increases, and therefore, the required level of brake performance increases. Also, when it rains or the humidity level is high, a stopping distance of the vehicle tends to increase when the vehicle is decelerated, and therefore, the required level of brake performance increases. That is, various elements that change the required level of brake performance may be used as the operating state of the vehicle.

The vehicle weight greatly varies depending on the number of occupants. Therefore, for example, the number of occupants may be detected using a sensor provided in a seat, or a sensor that detects that a seat belt is used, and the vehicle weight may be determined based on a value detected by multiplying the detected number of occupants by a standard body weight (for example 65 Kg). Also, for example, when the vehicle is stopped, the stroke of a suspension may be detected in an electronically-controlled suspension system, and the vehicle weight may be detected based on the detected value. Also, the inter-vehicle distance may be detected, for example, based on data obtained by inter-vehicle communication, or an output from a sensor that detects a distance between the vehicle and a preceding vehicle. Further, the weather and the humidity level may be detected, for example, based on information obtained by the navigation system provided in the vehicle.

The process of changing the negative pressure determination value F (P) according to the vehicle weight, the inter-vehicle distance, the weather, the humidity level, or the like may be implemented by configuring the negative pressure determination value change program using the element such as the vehicle weight, the inter-vehicle distance, the weather, or the humidity level, as the state of the vehicle. Further, more specifically, for example, the process may be implemented by storing, in the ROM, a negative pressure determination value map that defines the negative pressure determination value F (P) according to the corresponding element, and configuring the negative pressure determination value change program so that the negative pressure determination value map corresponding to the detected element is referred to, based on the detected element, and the negative pressure determination value F (P) corresponding to the detected value is newly read from the negative pressure determination value map.

In the embodiment, the calculation processes executed in step S12 have been separately described in detail with reference to the respective sub routines shown in FIGS. 4A to 4C. These sub routines may be simultaneously executed in parallel with each other in step S12. In this case, for example, the negative pressure determination value F (P) that is a negative value and is lowest among the negative pressure determination values F (P) calculated in the subroutines shown in FIGS. 4A to 4C may be used as a new negative pressure determination value F (P). This process may be implemented by configuring the negative pressure determination value change program so that the negative pressure determination value F (P) is changed to a new negative pressure determination value F (P) that is a negative value, and is lowest among a plurality of calculated negative pressure determination values F (P). The negative pressure determination value map shown in each of FIGS. 4D to 4F is an example of the negative pressure determination value map that appropriately shows the tendency of a change in the negative pressure determination value F (P). That is, the negative pressure determination value F (P) need not necessarily be changed as shown in each of FIGS. 4D to 4F. The negative pressure determination value may be appropriately set according to the state of the vehicle using an appropriate negative determination value map. Thus, it is possible to implement the ECU 40 that appropriately ensures the required level of brake performance.

The above-described embodiments are example embodiments of the invention. However, the invention is not limited to the embodiments. Various modifications may be made to the embodiments within the scope of the invention.

What is claimed is:

1. A control apparatus for a negative pressure generating apparatus, comprising:
an ejector that generates a negative pressure whose magnitude is larger than that of a negative pressure to be taken from an intake passage in an intake system for an internal combustion engine provided in a vehicle;
a state change device that makes the ejector function or stop functioning based on a result of a comparison between the negative pressure to be taken from the intake passage and a predetermined value; and
a predetermined value change device that changes the predetermined value according to an operating state of the vehicle.

2. The control apparatus according to claim 1, wherein the operating state of the vehicle is a vehicle speed of the vehicle.

3. The control apparatus according to claim 2, wherein:
when the negative pressure to be taken from the intake passage is a negative value larger than the predetermined value, the state change device makes the ejector function; and
the predetermined value change device decreases the predetermined value as the vehicle speed increases.

4. The control apparatus according to claim 1, wherein the operating state of the vehicle is a posture of the vehicle, which changes according to a slope of a road on which the vehicle travels.

5. The control apparatus according to claim 4, wherein:
when the negative pressure to be taken from the intake passage is a negative value larger than the predetermined value, the state change device makes the ejector function; and
the predetermined value change device decreases the predetermined value as the slope of the road increases when the slope of the road is a downward slope.

6. The control apparatus according to claim 1, wherein the operating state of the vehicle is a temperature of a coolant for the internal combustion engine.

7. The control apparatus according to claim 1, wherein:
when the negative pressure to be taken from the intake passage is a negative value larger than the predetermined value, the state change device makes the ejector function; and
the predetermined value change device increases the predetermined value as the temperature of the coolant for the internal combustion engine increases.

8. The control apparatus according to claim 1, further comprising
an atmospheric pressure correction device that corrects the predetermined value based on an atmospheric pressure.

9. The control apparatus according to claim 1, wherein the negative pressure to be taken from the intake passage is estimated based on a rotational speed of the internal combustion engine, and an opening degree of a throttle valve for the internal combustion engine.

10. The control apparatus according to claim 1, further comprising
a negative pressure detection sensor that is provided in the intake passage, and that detects a negative pressure in the intake passage, wherein the negative pressure to be taken from the intake passage is the negative pressure in the intake passage detected by the negative pressure detection sensor.

11. A control method for a negative pressure generating apparatus that includes an ejector that generates a negative pressure whose magnitude is larger than that of a negative pressure to be taken from an intake passage in an intake system for an internal combustion engine provided in a vehicle, the control method comprising:
making a comparison between the negative pressure to be taken from the intake passage and a predetermined value;
making the ejector function based on a result of the comparison; and
changing a predetermined value according to an operating state of the vehicle.
